(19) United States
(12) Patent Application Publication
(10) Pub. No.: US 2024/0070668 A1
(43) Pub. Date: Feb. 29, 2024

(54) PLATFORM-AGNOSTIC ENTITY IDENTIFICATION THROUGH COMPUTATIONAL MODELING

(71) Applicant: MASTERCARD INTERNATIONAL INCORPORATED, Purchase, NY (US)

(72) Inventors: Ravi Santosh ARVAPALLY, St. Louis, MO (US); Varun AJMERA, Toronto (CA)

(73) Assignee: MASTERCARD INTERNATIONAL INCORPORATED, Purchase, NY (US)

(21) Appl. No.: 17/894,910

(22) Filed: Aug. 24, 2022

(51) Int. Cl. G06Q 20/40

(52) U.S. Cl. CPC G06Q 20/4014

(57) ABSTRACT

The disclosure relates to methods and systems of generating a platform-agnostic identification of an entity through rules-based computational modeling of entity relationships. For example, the platform-agnostic identification of an entity may be used to identify an acquirer entity across different data platforms, such as payment networks, that each assign respective acquirer identifiers to the acquirer entity. The computational modeling may generate a mapping between a first acquirer identifier assigned by a first payment network to the acquirer entity and a second acquirer identifier assigned by a second payment network to the acquirer entity. The mapping may be based on an anchor value that is associated with both the first acquirer identifier and the second acquirer identifier. The mapping may be validated by multi-validation rules and/or issuer-validation rules that reduce false positive results that may occur through computational modeling.

### BACKGROUND

In a data platform, an entity may be identified using an entity identifier so that the entity is identifiable within the data platform. In some instances, the data platform may assign the entity identifier to the entity or the entity may select its own entity identifier. In either instance, the entity identifier may uniquely identify the entity within the data platform. There are many data platforms and each may identify entities with respective platform-specific entity identifiers for the entities that operate on them. Furthermore, a given entity may be associated with multiple data platforms and may be assigned with respective entity identifiers that uniquely identify that entity on these respective data platforms. It may therefore be difficult to identify an entity in a platform-agnostic way using data originating from different data platforms.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment of computationally modeling entity relationships for platform-agnostic entity identification;

FIG. 2 illustrates an entity diagram of entity relationships that are modeled for platform-agnostic identification of an acquirer entity;

FIG. 3 illustrates an example of computationally modeling entity relationships to generate a mapping of entity identifiers based on reference data records and multi-entity data records;

FIG. 4 illustrates an example of matched records based on matching by the entity relationship modeler;

FIG. 5 illustrates an example of the mapping generated by the entity relationship modeler;

FIG. 6 illustrates an example of a method of generating platform-agnostic entity identifier mappings;

FIG. 7 illustrates an example of a method of computationally modeling entity relationships for platform-agnostic entity identification; and

FIG. 8 illustrates an example of a computer system that may be implemented by devices illustrated in FIG. 1.

### DETAILED DESCRIPTION

The disclosure relates to methods and systems of generating a platform-agnostic identification of an entity through rules-based computational modeling of entity relationships. For example, a subject entity may be identified across different data platforms that each assign respective entity identifiers to the subject entity. The computational modeling may generate a mapping between a first subject entity identifier assigned by a first data platform to the subject entity and a second subject entity identifier assigned by a second data platform to the acquirer entity. The mapping may be based on an anchor value that is associated with both the first acquirer identifier and the second acquirer identifier.

The platform-agnostic identification of acquirer entities may be applied in various contexts. In one illustrative example context, the subject entity may be an acquirer entity and the data platforms may be various payment card networks. For example, the Mastercard® payment network may identify an acquirer entity using a Mastercard®-specific acquirer identifier and another payment network may identify that same acquirer entity using the other payment network's acquirer identifier. The acquirer entity may process payments on behalf of its merchant entities across different payment networks (to process different card network payments for the merchant entities) using its card-network-specific acquirer identifier.

In response to requests from acquirer entities, an issuer entity may provide the acquirer entity with an authorization response. In connection with processing the authorization response, the issuer entity may provide, to an alert subsystem, data records that include the acquirer identifier and a merchant descriptor assigned by the acquirer entity. Doing so may facilitate alert detection to determine whether the authorization should continue. It may be difficult to provide alerts to acquirer entities on this data alone in a platform-agnostic manner because the acquirer identifiers for a given acquirer entity is different across the different payment platforms. By computationally modeling the relationships between various entities, including the acquirer entities and merchant entities, the computer system may generate card-network-agnostic identifications of acquirer entities. For example, the computer system may map the acquirer's Mastercard-specific acquirer identifier to the acquirer's other network-specific acquirer identifier based on the modeled entity relationships.

With computational modeling, there may be a problem with false positive results. In the previous illustrative example, modeling entity relationships may result in false positive identifications of acquirer entities across card payment networks. To mitigate against these and other problems, the computer system may execute rules-based validation of platform-agnostic identifications. For example, the computer system may evaluate a rule that requires passing a sufficient validation threshold that specifies a number of identification matches, a rule that specifies consistency validation across different issuer entities, and/or other validation rules. Having described a high-level overview of system operations, attention will now turn to an example of a system environment in the context of platform-agnostic identifications of subject entities (such as acquirer entities) may be performed.

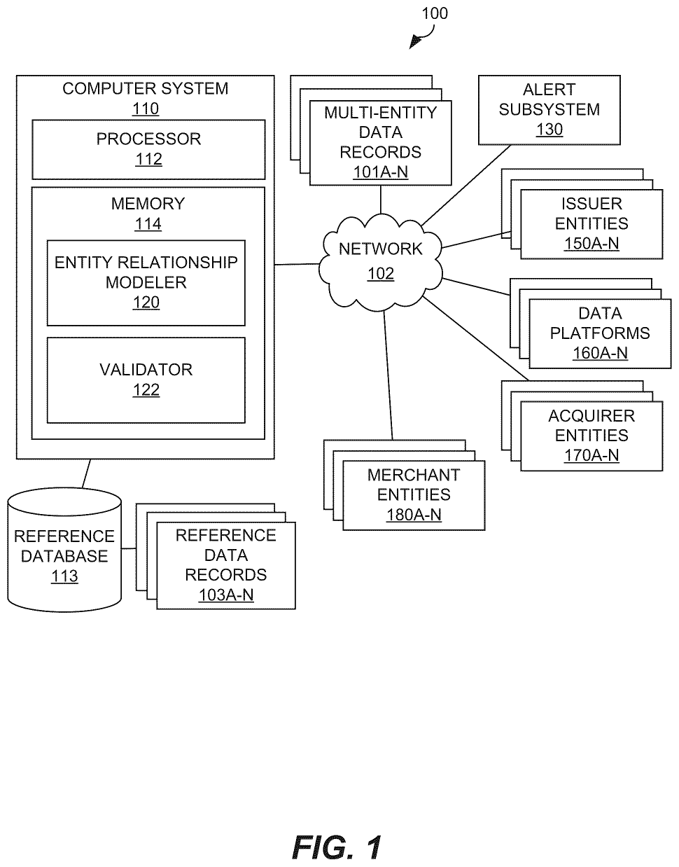

For example, FIG. 1 illustrates an example of a system environment 100 of computationally modeling entity relationships for platform-agnostic entity identification. The system environment 100 may include a computer system 110, issuer entities 150 (illustrated as issuer entities 150A-N), data platforms 160 (illustrated as data platforms 160A-N), acquirer entities 170 (illustrated as acquirer entities 170A-N), merchant entities 180 (illustrated as merchant entities 180A-N), and/or other features. At least some of the components of the system environment 100 may be connected to one another via a network 102, which may include the Internet, an intranet, a Personal Area Network, a LAN (Local Area Network), a WAN (Wide Area Network), a SAN (Storage Area Network), a MAN (Metropolitan Area Network), a wireless network, a cellular communications network, a Public Switched Telephone Network, and/or other network through which system environment 100 components may communicate.

The computer system 110 may include one or more computing devices that computationally model entity relationships to identify acquirer entities 170 across data platforms 160 based on merchant entities 180 that are serviced by respective acquirer entities 170. For example, the one or more computing devices of the computer system 110 may each include a processor 112, a memory 114, an entity relationship modeler 120, a validator 122, and/or other components.

The processor 112 may be a semiconductor-based microprocessor, a central processing unit (CPU), an application specific integrated circuit (ASIC), a field-programmable gate array (FPGA), and/or other suitable hardware device. Although the computer system 110 has been depicted as including a single processor 112, it should be understood that the computer system 110 may include multiple processors, multiple cores, or the like. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals.

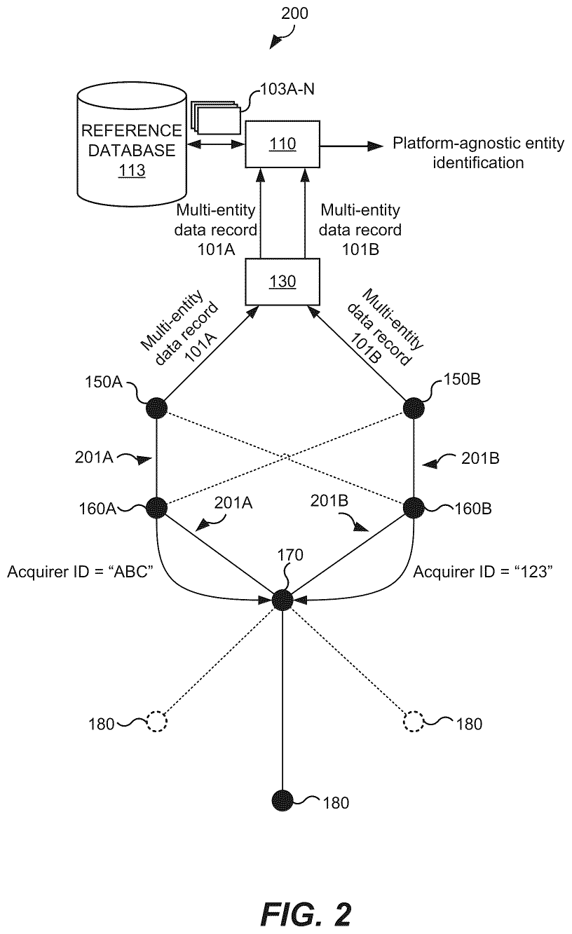

The term “computationally modeling” as used herein may refer to a computational analysis of multi-entity data records 101 to identify entity relationships. An entity relationship may refer to an association of two or more entities with one another, where such association may be recorded in a multi-entity data record 101. Reference will be made to FIG. 2 to describe illustrative examples of entities and entity relationships that may be computationally modeled by the computer system 110.

For example, FIG. 2 illustrates an entity diagram 200 of entity relationships that are modeled for platform-agnostic identification of an acquirer entity 170. Each entity is illustrated as a node represented as a circle in the entity diagram 200. Each entity may have an entity relationship with another entity, as illustrated by connected edges represented as lines in the entity diagram 200. As illustrated, the acquirer entity 170 is involved in entity relationships with a plurality of merchant entities 180, a plurality of issuer entities 150, and/or a plurality of data platforms 160. Hatched circles or hatched lines represent other examples of entities or entity relationships not expressly described for clarity.

The acquirer entity 170 may process payments on behalf of the plurality of merchant entities 180. Such payments may be processed on either a data platform 160A (such as the Mastercard® payment network), a data platform 160B (such as another payment network), or other data platforms 160 (not illustrated).

Each data platform 160 may assign the acquirer entity 170 with a respective acquirer identifier. For example, the data platform 160A may assign the acquirer entity 170 with a first acquirer identifier “ABC” while the data platform 160B may assign the acquirer entity 170 with a second acquirer identifier “123.” The data platform 160A may identify the acquirer entity 170 with the first acquirer identifier and data platform 160B may identify the acquirer entity 170 with the second acquirer identifier. Thus, the same acquirer entity 170 may be assigned with two different platform-specific acquirer identifiers by respective data platforms 160A and 160B. The acquirer entity 170 may be assigned with other platform-specific entity identifiers by other data platforms 160N (not illustrated in FIG. 2).

To illustrate entity relationships in an example operation, when a first customer of the merchant entity 180 presents a Mastercard® payment account for payment (such as through a payment card or other account identifying medium), the acquirer entity 170 may, on behalf of the merchant entity 180, transmit an authorization request message 201A to an issuer entity 150A (that issued the payment card to the customer) via the data platform 160A. If the customer of the merchant entity 180 presents another payment network-branded card for payment, the acquirer entity 170 may, on behalf of the merchant entity 180, transmit an authorization request message 201B to an issuer entity 150B via the data platform 160B. It should be noted that the authorization request message may be transmitted to a single issuer entity 150 depending on whether that issuer entity 150 issued both payment accounts.

Each authorization request message 201A or 201B from the acquirer entity 170 may include, among other things, a payment account identifier (such as a payment card account number), transaction details such as payment amount, the corresponding acquirer identifier (such as “ABC” or “123”) depending on the card network (also referred to as “card scheme”) used so that the respective data platform 160 may identify the acquirer entity 170, and a merchant descriptor. The merchant descriptor may include a description, assigned by the acquirer entity 170 (such as to identify the merchant), of the merchant entity 180 to which the authorization request message relates.

The data platform 160A may route the authorization request message 201A to the appropriate issuer entity 150 that issued a payment account identified by the payment account identifier. The issuer entity 150 may approve or deny the transaction and may send back an authorization response message through the data platform 160A to the acquirer entity 170. Further details of payment processing are well-known and omitted for clarity. Similar processing may be performed by the data platform 160B to process the authorization request message 201B to the issuer entity 150B and transmit an authorization response from the issuer entity 150B to the acquirer entity 170. In either instance, the acquirer entity 170 may indicate the authorization response to the merchant entity 180.

The issuer entity 150A or 150B (or other entity illustrated in the entity diagram 200) may generate a multi-entity data record 101A or 101B. The multi-entity data record 101A or 101B may include some or all of the data in the authorization request message 201A or 201B. For example, the multi-entity data record 101A or 101B may include the acquirer identifier (“ABC” or “123” depending the data platform 160A or 160B used), the merchant descriptor, and/or other data from the authorization request message 201A or 201B. The multi-entity data record 101 may include other information as well. The issuer entity 150A or 150B may transmit the multi-entity data record 101A or 101B to the alert subsystem 130, which may analyze the multi-entity data record 101A or 101B to determine whether an alert should be generated. For instance, the alert subsystem 130 may detect potential fraudulent transactions and alert relevant parties, such as the issuer entity 150A or 150B.

If the multi-entity data record 101 originated from a transaction processed by the data platform 160A, the alert subsystem 130 will be able to identify the acquirer entity 170 based on the acquirer identifier (“ABC” assigned by the data platform 160A) in the multi-entity data record 101. However, the alert subsystem 130 may be unable to determine the acquirer identifier of the acquirer entity 170 assigned by the data platform 160B or other data platform 160. As such, to identify the acquirer identifier (“123”) of the acquirer entity 170 by the data platform 160B, the computer system 110 may model the entity relationships to generate platform-agnostic identifications of acquirer entities 170 based on the multi-entity data record 101A or 101B from the alert subsystem 130. In some examples, the computer system 110 may generate platform-agnostic identifications of acquirer entities 170 based on multi-entity data records 101 and reference data records in the reference database 113. It should be noted that a portion of all of a given multi-entity data record 101 may be stored later as a reference data record to serve as a known instance of an acquirer identifier mapping to a merchant descriptor.

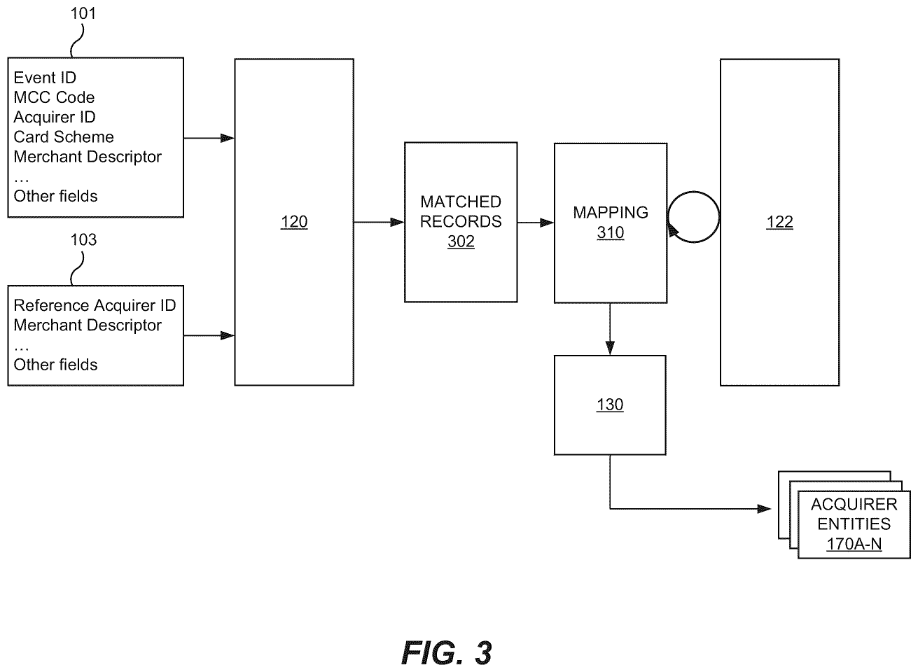

FIG. 3 illustrates an example of computationally modeling entity relationships to generate a mapping 310 of entity identifiers based on reference data records 103 and multi-entity data records 101. The reference data records 103 may each include a reference acquirer identifier (“ID”), a merchant descriptor, and/or other fields. The reference acquirer ID and merchant descriptor may therefore be stored in association with each other (in a reference data record 103) to represent a known acquirer identifier for an acquirer entity 170 identified by the reference acquirer ID. The multi-entity data records 101 may each include an event ID (which identifies an alert event), a merchant category code (“MCC code”), an acquirer ID, a card scheme used (identifies the data platform 160 that is associated with the multi-entity data record 101), a merchant descriptor, and/or other fields.

To generate the mapping, the entity relationship modeler 120 may compare the reference data records 103 with the multi-entity data records 101 based on an anchor value of a data field that is common to both. For example, the entity relationship modeler 120 may match merchant descriptors in the reference data records 103 and the multi-entity data records 101 to generate matched records 302.

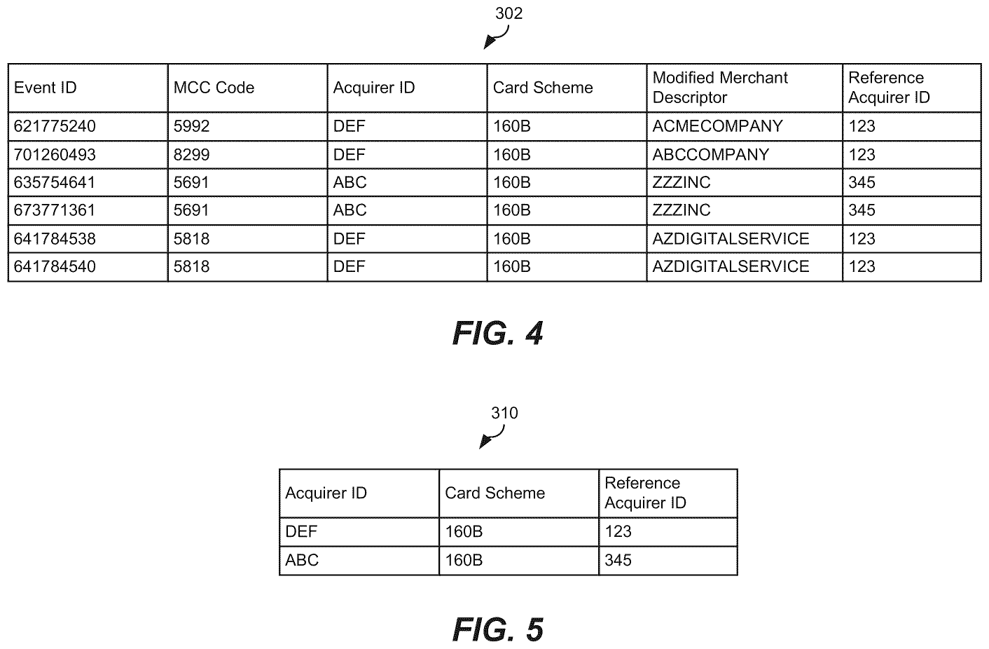

FIG. 4 illustrates an example of matched records 302 based on matching by the entity relationship modeler 120. The matched records 302 may include data from reference data records 103 matched with and combined with data from multi-entity data records 101. For instance, the event ID, MCC code, acquirer ID, card scheme and modified merchant descriptor may be from the multi-entity data records 101 and the modified merchant descriptor and the reference acquirer ID may be from the reference data records 103.

Each row in the matched records 302 represents an instance in which a modified merchant descriptor was matched, such as based on exact match string comparisons, fuzzy match string comparisons, word distance scoring, and/or other string-matching functions. For example, an acquirer entity 170 identified by the acquirer ID “DEF” on the data platform 160B may process payments on behalf of its merchant entity that the acquirer entity 170 refers to as “ACMECOMPANY” (in this case, “ACMECOMPANY” is an example of a modified merchant descriptor after removal of any source-specific data, examples of which are described below). The entity relationship modeler 120 may have matched this record with a reference data record 103 in which an acquirer entity 170 identified by the acquirer ID “123” on the data platform 160A (for example, the Mastercard® payment network) also referred to a merchant entity 180 as “ACMECOMPANY” (which is also a modified merchant descriptor after removal of any source-specific data). Thus, based on the matching, the entity relationship modeler 120 may merge together the multi-entity data record 101 and the reference data record 103. Additional rows in the matched records 302 represent records that were similarly merged by the entity relationship modeler 120. Based on the matched records 302, the entity relationship modeler 120 may generate the mapping 310.

The entity relationship modeler 120 may assume that a given acquirer entity 170 will refer to the same merchant entity 180 using the same merchant descriptor regardless of whether the acquirer entity 170 processes payments for the merchant entity 180 via data platform 160A or data platform 160B. By leveraging this assumed use, and computationally modeling transactions made by the acquirer entity 170 across different data platforms 160, the entity relationship modeler 120 may generate platform-agnostic identifications of the acquirer entity 170. In particular, the entity relationship modeler 120 may discover the second acquirer ID (“123”) assigned by the data platform 160B to the acquirer entity 170 based on reference data records that include the first acquirer ID (“ABC”) assigned by the data platform 160A to the acquirer entity 170. As such, the entity relationship modeler 120 may determine that the acquirer entity 170 is identified by the data platform 160A using the first acquirer ID (“ABC”) and is identified by the data platform 160B using the second acquirer ID (“123”).

In some examples, the comparison may include matching reference data records 103 of known acquirer IDs from a first data platform 160 (such as stored in the reference data table) to multi-entity data record 101 of acquirer IDs on a second data platform 160. To illustrate, if an acquirer ID (“ABC”) for an acquirer entity 170 is known on data platform 160A, the entity relationship modeler 120 may identify the acquirer ID (“123”) for the same acquirer entity 170 on data platform 160B based on modeling the multi-entity data records 101.

In some examples, to match the merchant descriptors from the reference data records 103 and the multi-entity data records 101, the entity relationship modeler 120 may first modify the merchant descriptors. In these examples, the entity relationship modeler 120 may match modified merchant descriptors. This is because the merchant descriptors may, in some instances, include source-specific data that may make matching difficult. For example, source-specific data may include special symbols, whitespace, prefixes, suffixes, metadata and/or other source-specific data that may be unneeded for matching and may render matching inaccurate. To solve this problem, the entity relationship modeler 120 may modify merchant descriptors to remove the source-specific data. For example, a merchant descriptor “ACMECOMPANY*1234567-WILMINGTON DE” may be modified by removing source-specific data to generate a modified merchant descriptor “ACMECOMPANY1234567WILMINGTONDE”. In this example, the source-specific data “*”, “-” and whitespace were removed.

The entity relationship modeler 120 generate a mapping 310 based on the matched records 302. FIG. 5 illustrates an example of the mapping 310 generated by the entity relationship modeler 120. Based on common modified merchant descriptors (or merchant descriptors if removing source-specific data is unnecessary), the entity relationship modeler 120 may map the acquirer ID “DEF” assigned by the data platform 160B with the reference acquirer ID “123” assigned by the data platform 160A. Likewise, the entity relationship modeler 120 may map the acquirer ID “ABC” assigned by the data platform 160B with the reference acquirer ID “345” assigned by the data platform 160A. It should be noted that merchant descriptors or modified merged descriptors may be used during matching by the entity relationship modeler 120.

The entity relationship modeler 120 may operate on an assumption that a given acquirer entity 170 will refer to the same merchant entity 180 using the same merchant descriptor when transmitting authorization request messages via either the data platform 160A, the data platform 160B, or other data platforms 160N. Thus, while the acquirer entity 170 will include a first acquirer identifier when a first card scheme of the data platform 160A is used and a second acquirer identifier when a second card scheme of the data platform 160B is used, the acquirer entity 170 will use the same merchant descriptor to process transactions for the same merchant entity 180 regardless of whether the first card scheme or the second card scheme is used.

The validator 122 may validate the mapping 310 based on one or more validation rules. For example, the validator 122 may validate the mapping based on a multi-entity validation rule that specifies that a number of modified merchant descriptor matches between data records meet or exceed a threshold match number for a mapping between a first acquirer ID and a second acquirer ID.

For example, referring to FIGS. 4 and 5, the validator 122 may determine that the mapping between acquirer ID “DEF” assigned by the data platform 160B and the acquirer ID “123” assigned by the data platform 160A includes four instances of modified merchant descriptor matches “ACMECOMPANY,” “ABCCOMPANY,” and two instances of “AZDIGITALSERVICE.” Similarly, the validator 122 may determine that the mapping between acquirer ID “ABC” assigned by the data platform 160B and the acquirer ID “345” assigned by the data platform 160A includes two different instances of modified merchant descriptor matches “ZZZINC.” If the threshold match number is two, the validator 122 may validate both mappings. If the threshold match number is greater than two, the validator 122 may validate only the mapping between “DEF” and “123.” It should be noted that the match count may be based on unique modified descriptor matches, rather than instance matches. For example, if using unique modified descriptor matches, the match count may be three for the mapping “DEF” and “123” and only one for the mapping “ABC” and “345.”

In another example, the validator 122 may validate the mapping based on an issuer validation rule that specifies that a number of modified merchant descriptor matches between data records meet or exceed a threshold match number for a mapping between a first acquirer ID and a second acquirer ID from different issuer entities 150. This issuer validation rule is similar to the multi-record validation rule in that a threshold number of matches is required for validation, but differs in that each match count must be based on different issuer entities 150 that submitted a multi-entity data record 101. In other words, the issuer validation rule ensures that validated mapping 310 are based on a threshold number of acquirer ID information of issuer entities 150 that is consistent with acquirer ID information of other issuer entities 150. When validated, the mapping 310 may be used by the alert subsystem 130 to generate alerts to acquirer entities 170A-N. For example, the alert subsystem 130 may receive an alert involving a first entity identifier; and identify the second entity identifier based on the mapping 310 and the first entity identifier contained in the alert. The alert subsystem 130 may access an electronic contact (such as an email address) associated with the second entity identifier, and transmit, via the electronic contact, an alert notification to the second acquirer entity identified by the second entity identifier.

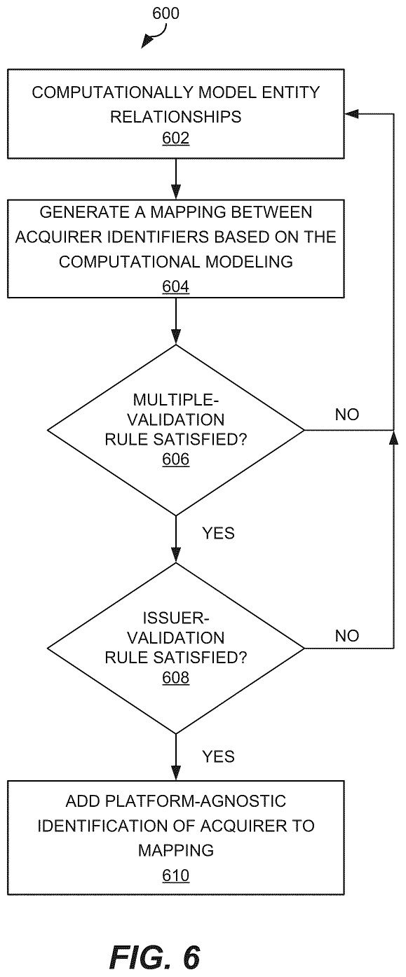

FIG. 6 illustrates an example of a method 600 of generating platform-agnostic entity identifier mappings.

At 602, the method 600 may include computationally modeling entity relationships. For example, the method 600 may include comparing multi-entity data records 101 with reference data records 103 to identify anchor values in a data field that is common to the multi-entity data records 101 and the reference data records 103. In particular, the anchor value may include a merchant descriptor that is assigned by acquirer entities 170 to the merchant entities 180 for payment processing over data platforms 160A-N. In this context, different data platforms 160A-N may refer to card payment networks, an example of which is the Mastercard® payment network.

At 604, the method 600 may include generating a mapping entry (such as an entry in the mapping 310) between acquirer identifiers based on the computational modeling. A mapping entry may refer to at least two acquirer identifiers that have been matched together because they share an anchor value. For example, each of the at least two acquirer identifiers may be associated with an acquirer entity 170 that submitted the same or similar merchant descriptor in connection with a transaction and therefore are candidates for referring to the same acquirer entity 170. In other words, the mapping entry infers that a single acquirer entity 170 is referred to by the at least two acquirer identifiers.

At 606, the method 600 may include determining whether the mapping entry satisfies a multi-entity validation rule. If the multi-entity validation rule has not been satisfied, then processing may return to operation 602 to continue computationally modeling entity relationships based on incoming multi-entity data records 101 (which may be received periodically from issuer entities 150 and/or other entities described herein).

If the mapping entry satisfies the multi-entity validation rule, at 608, the method 600 may include determining whether the mapping entry satisfies an issuer validation rule. If the mapping entry does not satisfy the issuer validation rule, then processing may return to operation 602 to continue computationally modeling entity relationships based on incoming multi-entity data records 101. If the issuer validation rule has been satisfied, at 610, the method 600 may include updating the mapping 310 to include the mapping entry.

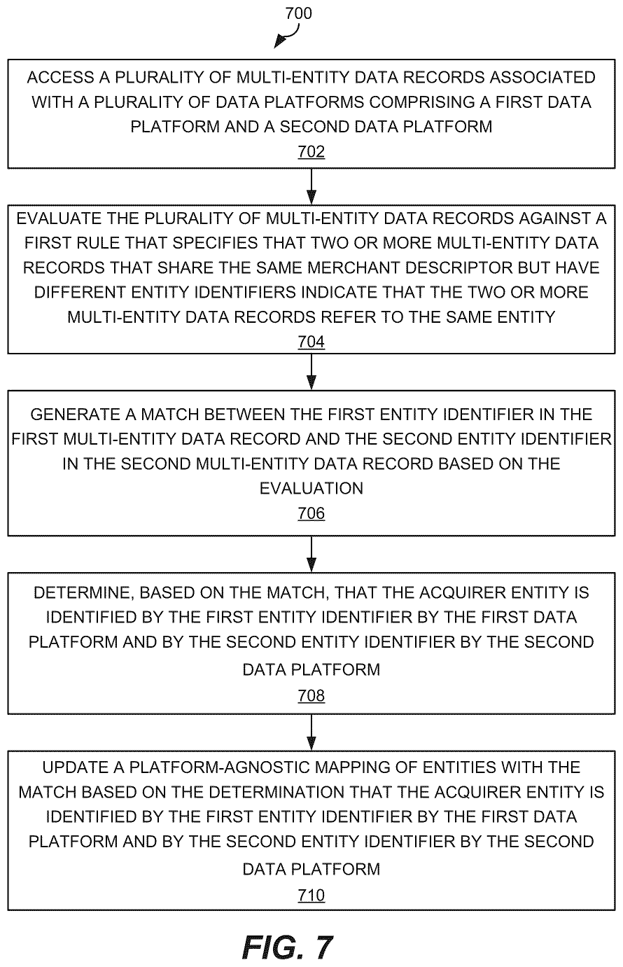

FIG. 7 illustrates an example of a method 700 of computationally modeling entity relationships for platform-agnostic entity identification.

At 702, the method 700 may include accessing a plurality of multi-entity data records (such as multi-entity data records 101) associated with a plurality of data platforms (such as data platforms 160A-N) comprising a first data platform (such as 160A) and a second data platform (such as 160B). The plurality of multi-entity data records may include a first multi-entity data record 101A associated with the first data platform 160A and a second multi-entity data record 101B associated with the second data platform 160B.

At 704, the method 700 may include evaluating the plurality of multi-entity data records against a first rule that specifies that two or more multi-entity data records that share the same merchant descriptor but have different entity identifiers indicate that the two or more multi-entity data records refer to the same entity.

At 706, the method 700 may include generating a match (such as an entry in matched records 302) between the first entity identifier (such as a first acquirer ID) in the first multi-entity data record and the second entity identifier (such as a second acquirer ID) in the second multi-entity data record based on the evaluation.

At 708, the method 700 may include determining, based on the match, that the acquirer entity is identified by the first entity identifier by the first data platform and by the second entity identifier by the second data platform.

At 710, the method 700 may include updating a platform-agnostic mapping (such as mapping 310) of entities with the match based on the determination that the acquirer entity is identified by the first entity identifier by the first data platform and by the second entity identifier by the second data platform.

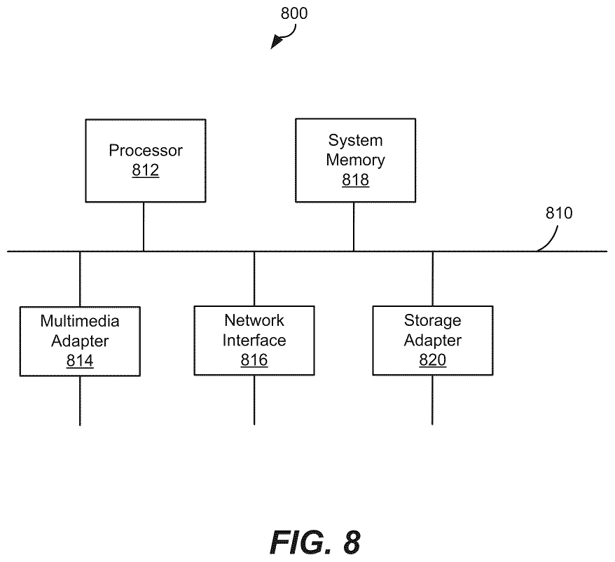

FIG. 8 illustrates an example of a computer system 800 that may be implemented by devices illustrated in FIG. 1. The computer system 800 may be part of or include the system environment 100 to perform the functions and features described herein. For example, various ones of the devices of components of system environment 100 (such as the computer system 110, the alert subsystem 130, the issuer entities 150, the data platforms 160, the acquirer entities 170, and the merchant entities 180) may be implemented based on some or all of the computer system 800.

The computer system 800 may include, among other things, an interconnect 810, a processor 812, a multimedia adapter 814, a network interface 816, a system memory 818, and a storage adapter 820.

The interconnect 810 may interconnect various subsystems, elements, and/or components of the computer system 800. As shown, the interconnect 810 may be an abstraction that may represent any one or more separate physical buses, point-to-point connections, or both, connected by appropriate bridges, adapters, or controllers. In some examples, the interconnect 810 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 810 may allow data communication between the processor 812 and system memory 818, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 812 may control operations of the computer system 800. In some examples, the processor 812 may do so by executing instructions such as software or firmware stored in system memory 818 or other data via the storage adapter 820. In some examples, the processor 812 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 814 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 816 may provide the computer system 800 with an ability to communicate with a variety of remote devices over a network. The network interface 816 may include, for example, an Ethernet adapter, a Fibre Channel adapter, and/or other wired- or wireless-enabled adapter. The network interface 816 may provide a direct or indirect connection from one network element to another, and facilitate communication and between various network elements.

The storage adapter 820 may connect to a standard computer readable medium for storage and/or retrieval of information, such as a fixed disk drive (internal or external).

Other devices, components, elements, or subsystems (not illustrated) may be connected in a similar manner to the interconnect 810 or via a network. The devices and subsystems can be interconnected in different ways from that shown in FIG. 8. Instructions to implement various examples and implementations described herein may be stored in computer-readable storage media such as one or more of system memory 818 or other storage. Instructions to implement the present disclosure may also be received via one or more interfaces and stored in memory. The operating system provided on computer system 800 may be MS-DOS®, MS-WINDOWS®, OS/2®, OS X®, IOS®, ANDROID®, UNIX®, Linux®, or another operating system.

In operation, the disclosed systems and methods may be used in various contexts. In one example context, the disclosure may be implemented to detect anomalous alerts for chargebacks. Alert for chargebacks may avoids chargebacks by connecting issuers and merchants over transactions pointed by consumers as dispute/fraud. Issuer entities 150 provide this data to the alert subsystem 130 in near-real-time and the alert subsystem 130 forwards this to appropriate merchant and provides a merchant response back to the issuer entity 150 within a time-window. In this context, a multi-entity data record 101 may refer to data relating to the chargeback alerts. With the ability by the computer system 110 to identify acquirer entities 170 in a platform-agnostic matter across different payment card networks (data platforms 160), the alert subsystem 130 is able to target acquirer entities 170 with these alerts so that multiple entities in the payment chain may be informed of these and other types of alerts, expanding the reach and scale of such alert detection and mitigation.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “101A-N” does not refer to a particular number of instances of 101A-N, but rather “two or more.”

The databases (such as the reference database 113) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

While the disclosure has been described in terms of various specific embodiments, those skilled in the art will recognize that the disclosure can be practiced with modification within the spirit and scope of the claims.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system of generating a platform-agnostic identification of an entity through rules-based computational modeling to identify the entity from among platform-specific entity identifiers assigned to the entity, comprising:
a processor programmed to:
access a plurality of multi-entity data records associated with a plurality of data platforms comprising a first data platform and a second data platform,
the plurality of multi-entity data records comprising a first multi-entity data record associated with the first data platform and a second multi-entity data record associated with the second data platform,
the first data platform having assigned an acquirer entity with a first entity identifier and the second data platform having assigned the acquirer entity with a second entity identifier different than the first entity identifier such that the acquirer entity is identified by different entity identifiers by different data platforms,
the acquirer entity having assigned a merchant entity with an entity descriptor to identify the merchant entity;
evaluate the plurality of multi-entity data records against a first rule that specifies that two or more multi-entity data records that share the same merchant descriptor but have different entity identifiers indicate that the two or more multi-entity data records refer to the same entity;
generate a match between the first entity identifier in the first multi-entity data record and the second entity identifier in the second multi-entity data record based on the evaluation;
determine, based on the match, that the acquirer entity is identified by the first entity identifier by the first data platform and by the second entity identifier by the second data platform; and
update a platform-agnostic mapping of entities with the match based on the determination that the acquirer entity is identified by the first entity identifier by the first data platform and by the second entity identifier by the second data platform.

2. The system of claim 1, wherein the processor is further programmed to:
evaluate the plurality of multi-entity data records against a multi-entity validation rule that specifies that a mapping between the acquirer identifiers be validated when the mapping is confirmed a threshold number of times; and
wherein the platform-agnostic mapping is updated based on confirmation that the multi-entity validation rule has been satisfied.

3. The system of claim 1, wherein the processor is further programmed to:
evaluate the plurality of multi-entity data records against an issuer validation rule that specifies that a mapping between the acquirer identifiers be validated when the mapping is confirmed across a plurality of issuer entities a threshold number of times; and
wherein the platform-agnostic mapping is updated based on confirmation that the issuer validation rule has been satisfied.

4. The system of claim 1, wherein the processor is further programmed to:
evaluate the plurality of multi-entity data records against a multi-entity validation rule that specifies that a mapping between the acquirer identifiers be validated when the mapping is confirmed a threshold number of times;
evaluate the plurality of multi-entity data records against an issuer validation rule that specifies that the mapping between the acquirer identifiers be validated when the mapping is confirmed across a plurality of issuer entities a threshold number of times; and
wherein the platform-agnostic mapping is updated based on confirmation that the multi-entity validation rule and the issuer validation rule have both been satisfied.

5. The system of claim 1, wherein the first multi-entity data record is accessed from an alerts database, and wherein the second multi-entity data record is accessed from a reference database.

6. The system of claim 5, wherein entries in the alerts database are matched against entries in the reference database.

7. The system of claim 1, wherein the processor is further programmed to:
receive an alert involving the first entity identifier;
identify the second entity identifier based on the mapping and the first entity identifier contained in the alert;
access an electronic contact associated with the second entity identifier; and
transmit, via the electronic contact, an alert notification to the entity.

8. The system of claim 1, wherein the first data platform comprises a first payment network and the second data platform comprises a second data platform.

9. A method of generating a platform-agnostic identification of an entity through rules-based computational modeling to identify the entity from among platform-specific entity identifiers assigned to the entity, the method comprising:
accessing, by a processor, a plurality of multi-entity data records associated with a plurality of data platforms comprising a first data platform and a second data platform,
the plurality of multi-entity data records comprising a first multi-entity data record associated with the first data platform and a second multi-entity data record associated with the second data platform,
the first data platform having assigned an acquirer entity with a first entity identifier and the second data platform having assigned the acquirer entity with a second entity identifier different than the first entity identifier such that the acquirer entity is identified by different entity identifiers by different data platforms,
the acquirer entity having assigned a merchant entity with an entity descriptor to identify the merchant entity;
evaluating, by the processor, the plurality of multi-entity data records against a first rule that specifies that two or more multi-entity data records that share the same merchant descriptor but have different entity identifiers indicate that the two or more multi-entity data records refer to the same entity;
generating, by the processor, a match between the first entity identifier in the first multi-entity data record and the second entity identifier in the second multi-entity data record based on the evaluation;
determining, by the processor, based on the match, that the acquirer entity is identified by the first entity identifier by the first data platform and by the second entity identifier by the second data platform; and
updating, by the processor, a platform-agnostic mapping of entities with the match based on the determination that the acquirer entity is identified by the first entity identifier by the first data platform and by the second entity identifier by the second data platform.

10. The method of claim 9, further comprising:
evaluating the plurality of multi-entity data records against a multi-entity validation rule that specifies that a mapping between the acquirer identifiers be validated when the mapping is confirmed a threshold number of times; and
wherein the platform-agnostic mapping is updated based on confirmation that the multi-entity validation rule has been satisfied.

11. The method of claim 9, further comprising:
evaluating the plurality of multi-entity data records against an issuer validation rule that specifies that a mapping between the acquirer identifiers be validated when the mapping is confirmed across a plurality of issuer entities a threshold number of times; and
wherein the platform-agnostic mapping is updated based on confirmation that the issuer validation rule has been satisfied.

12. The method of claim 9, further comprising:
evaluating the plurality of multi-entity data records against a multi-entity validation rule that specifies that a mapping between the acquirer identifiers be validated when the mapping is confirmed a threshold number of times;
evaluating the plurality of multi-entity data records against an issuer validation rule that specifies that the mapping between the acquirer identifiers be validated when the mapping is confirmed across a plurality of issuer entities a threshold number of times; and
wherein the platform-agnostic mapping is updated based on confirmation that the multi-entity validation rule and the issuer validation rule have both been satisfied.

13. The method of claim 9, wherein the first multi-entity data record is accessed from an alerts database, and wherein the second multi-entity data record is accessed from a reference database.

14. The method of claim 13, wherein entries in the alerts database are matched against entries in the reference database.

15. The method of claim 9, further comprising:
receiving an alert involving the first entity identifier;
identifying the second entity identifier based on the mapping and the first entity identifier contained in the alert;
accessing an electronic contact associated with the second entity identifier; and
transmitting, via the electronic contact, an alert notification to the entity.

16. The method of claim 9, wherein the first data platform comprises a first payment network and the second data platform comprises a second data platform.

17. A computer readable medium for generating a platform-agnostic identification of an entity through rules-based computational modeling to identify the entity from among platform-specific entity identifiers assigned to the entity, the computer readable medium storing instructions that, when executed by a processor, programs the processor to:
access a plurality of multi-entity data records associated with a plurality of data platforms comprising a first data platform and a second data platform,
the plurality of multi-entity data records comprising a first multi-entity data record associated with the first data platform and a second multi-entity data record associated with the second data platform,
the first data platform having assigned an acquirer entity with a first entity identifier and the second data platform having assigned the acquirer entity with a second entity identifier different than the first entity identifier such that the acquirer entity is identified by different entity identifiers by different data platforms,
the acquirer entity having assigned a merchant entity with an entity descriptor to identify the merchant entity;
evaluate the plurality of multi-entity data records against a first rule that specifies that two or more multi-entity data records that share the same merchant descriptor but have different entity identifiers indicate that the two or more multi-entity data records refer to the same entity;
generate a match between the first entity identifier in the first multi-entity data record and the second entity identifier in the second multi-entity data record based on the evaluation;
determine, based on the match, that the acquirer entity is identified by the first entity identifier by the first data platform and by the second entity identifier by the second data platform; and
update a platform-agnostic mapping of entities with the match based on the determination that the acquirer entity is identified by the first entity identifier by the first data platform and by the second entity identifier by the second data platform.

18. The computer readable medium of claim 17, wherein the instructions, when executed by the processor further programs the processor to:
evaluate the plurality of multi-entity data records against a multi-entity validation rule that specifies that a mapping between the acquirer identifiers be validated when the mapping is confirmed a threshold number of times; and
wherein the platform-agnostic mapping is updated based on confirmation that the multi-entity validation rule has been satisfied.

19. The computer readable medium of claim 17, wherein the instructions, when executed by the processor further programs the processor to:
evaluate the plurality of multi-entity data records against an issuer validation rule that specifies that a mapping between the acquirer identifiers be validated when the mapping is confirmed across a plurality of issuer entities a threshold number of times; and
wherein the platform-agnostic mapping is updated based on confirmation that the issuer validation rule has been satisfied.

20. The computer readable medium of claim 17, wherein the instructions, when executed by the processor further programs the processor to:
evaluate the plurality of multi-entity data records against a multi-entity validation rule that specifies that a mapping between the acquirer identifiers be validated when the mapping is confirmed a threshold number of times;
evaluate the plurality of multi-entity data records against an issuer validation rule that specifies that the mapping between the acquirer identifiers be validated when the mapping is confirmed across a plurality of issuer entities a threshold number of times; and
wherein the platform-agnostic mapping is updated based on confirmation that the multi-entity validation rule and the issuer validation rule have both been satisfied.
